(19) United States
(12) Patent Application Publication
(10) Pub. No.: US 2008/0168542 A1
(43) Pub. Date: Jul. 10, 2008

(54) Control terminal, image processing apparatus, control system, control program and control method

(75) Inventor: Tomonori Sato, Machida-shi (JP)

Correspondence Address: SIDLEY AUSTIN LLP, 717 NORTH HARWOOD, SUITE 3400, DALLAS, TX, 75201, US

(73) Assignee: KONICA MINOLTA BUSINESS TECHNOLOGIES, INC.

(21) Appl. No.: 11/999,632

(22) Filed: Dec. 6, 2007

(30) Foreign Application Priority Data
Jan. 10, 2007 (JP) 2007-002323

(51) Int. Cl. G06F 21/20

(52) U.S. Cl. 726/5

(57) ABSTRACT

A control terminal including: an interface section to load a portable memory device; an authentication information issue section which issues authentic information; an authentic information registration section which registers the authentic information in a storage section; and an authentication processing section which controls to determine whether the authentication information registered in the storage section is stored in the portable memory device loaded in the interface section, and in a case where the authentication information is stored in the portable memory device, controls to permit a login as a registered user, while in a case where the authentication information is not stored in the portable memory device, controls to permit a login as a guest user.

### CROSS REFERENCE TO RELATED APPLICATION

The present application is based on Japanese Patent Application No. 2007-002323 filed with Japanese Patent Office on Jan. 10, 2007, the entire content of which is hereby incorporated by reference.

### BACKGROUND OF THE INVENTION

1. Field of the Invention

The present invention relates an authentication control terminal, an image processing apparatus, a control system and a control program, and a control method, each of which performs control based on authentication information stored in a portable device or machine.

2. Description of Prior Art

In recent years, with increasing use of office satellites and SOHO (small office/home office) and the increase in the number of mobile users, the need for a server based control system which can perform driverless printing at a shared printer has increased.

For example, in the case of use in hotels or the like, a system may be considered in which user registration may be performed via a web browser from a computer terminal in the cabin or from a mobile telephone or the like, and the issued authentication information (ID, password, or the like) is input and authenticated at a touch panel of a control terminal in the hotel lobby and then the authenticated user is permitted to print. However, in this type of system, there is need to remember the ID and password by writing it down on notepaper or the like. This has been problematic in that it is a big burden on the user and furthermore sometimes input errors occur.

In order to solve the problems described above, a system has been disclosed in which the account ID is registered in a USB (Universal Serial Bus) memory or the like and authentication is performed using this. (See Japanese Unexamined Patent Publication No. 2002-312326 (JP2002-312326A) for example). Furthermore Japanese Unexamined Patent Publication No. 2005-129007 (JP2005-129007A) discloses technology in which authentication information is authenticated using USB memory in which authentication information is stored in advance and print control is performed using printing jobs registered in advance in a data center server.

However, the method of the prior art in which the USB memory is used is inconvenient because only the user that has accessed the authentication information has permission to print and a user that has not accessed the authentication information does not get permission to print. For example, if this method is used at a hotel or the like, a resident staying at the hotel can use the shared printers and the like, but a nonresident who is not staying at the hotel but is having a business meeting in the lobby may not use the shared printers for printing and thus service cannot be provided for all of the hotel users.

The conventional method shown in JP2005-129007A is also inconvenient, because the print jobs must be registered in advance at the data center server, which prevents document data stored in memory devices that can be carried around (called portable memory devices hereinafter) such as USB memory and the like, from being printed. For example, in the case of use at a hotel or the like, job registration must be done at the server using a computer terminal or the like that is set up in the cabin and quick printing at that location cannot be done.

### SUMMARY

The present invention was conceived in view of the problems described above and the main object of the present invention is to provide a control terminal, an image processing apparatus, a control system, and a control program and a control method each of which is more convenient for users.

To achieve at least one of the abovementioned objects, a control terminal reflecting one aspect of the present invention includes an interface section to load a portable memory device;

an authentication information issue section which issues authentic information;

an authentic information registration section which registers the authentic information in a storage section; and

an authentication processing section which controls to determine whether the authentication information registered in the storage section is stored in the portable memory device loaded in the interface section, and in a case where the authentication information is stored in the portable memory device, controls to permit a login as a registered user, while in a case where the authentication information is not stored in the portable memory device, controls to permit a login as a guest user.

A control terminal reflecting another aspect of the present invention includes:

a near field communication section which performs data communication with a near field communication tag of a portable terminal;

an authentication information issue section which issues authentic information;

an authentic information registration section which registers the authentic information in a storage section; and

an authentication processing section which controls to determine whether the authentication information registered in the storage section is stored in the near field communication tag which is performing data communication with the near field communication section, and in a case where the authentication information is stored in the near field communication tag, controls to permits a login as a registered user, while in a case where the authentication information is not stored in the near field communication tag, controls to permit a login as a guest user.

In either of the above control terminals, it is preferable to further comprises: a print instruction section in which an application that has been stored in memory in advance is used for converting the document data that is stored in the portable memory device or the near field communication tag to print data of page description language and print instruction is given to the image forming device that is connected to the control terminal based on the print data.

### BRIEF DESCRIPTION OF THE DRAWINGS

These and other objects, advantages and features of the invention will become apparent from the following description thereof taken in conjunction with the accompanying drawings in which:

FIG. 1 is a pattern diagram showing the configuration of the control system of the first embodiment of the present invention;

FIG. 2 is a block diagram showing the configuration of the user terminal of the first embodiment of the present invention;

FIG. 3 is a block diagram showing the configuration of the control terminal of the first embodiment of the present invention;

FIGS. 4(a) and (b) are block diagrams showing the configuration of the image forming apparatus of the first embodiment of the present invention;

FIG. 5 shows an example showing the configuration of a screen (login ID issue screen) displayed on the user terminal of the first embodiment of the present invention;

FIG. 6 shows an example of the configuration of a screen (detailed information registration screen) displayed on the user terminal of the first embodiment of the present invention;

FIG. 7 shows an example of the configuration of a screen (login ID issue completion screen) displayed on the user terminal of the first embodiment of the present invention;

FIG. 8 shows an example of the configuration of a screen (login ID save screen) displayed on the user terminal of the first embodiment of the present invention;

FIG. 9 shows an example of the configuration of a screen (save completion screen) displayed on the user terminal of the first embodiment of the present invention;

FIG. 10 shows an example of the configuration of a screen (document registration screen) displayed on the user terminal of the first embodiment of the present invention;

FIG. 11 shows an example of the configuration of a screen (login screen) displayed on the control terminal of the first embodiment of the present invention;

FIG. 12 shows an example of the configuration of a screen (login screen) displayed on the control terminal of the first embodiment of the present invention;

FIG. 13 shows an example of the configuration of a screen (menu screen) displayed on the control terminal of the first embodiment of the present invention;

FIG. 14 shows an example of the configuration of a screen (menu screen) displayed on the control terminal of the first embodiment of the present invention;

FIG. 15 shows an example of the configuration of a screen (media print screen) displayed on the control terminal of the first embodiment of the present invention;

FIG. 16 shows an example of the configuration of a screen (server print screen) displayed on the control terminal of the first embodiment of the present invention;

FIG. 17 shows an example of the configuration of a screen (scan to USB screen) displayed on the control terminal of the first embodiment of the present invention;

FIG. 18 shows an example of the configuration of a screen (scan to USB screen) displayed on the control terminal of the first embodiment of the present invention;

FIG. 19 is a flowchart showing the operation of the user terminal of the first embodiment of the present invention;

FIG. 20 is a flowchart showing operation (login ID issue operation) of the control terminal of the first embodiment of the present invention;

FIG. 21 is a flowchart showing operation (login operation) of the control terminal of the first embodiment of the present invention;

FIG. 22 is a flowchart showing operation (function use operation) of the control terminal of the first embodiment of the present invention;

FIG. 23 is a flowchart showing operation (function use operation) of the control terminal of the first embodiment of the present invention;

FIG. 24 shows another configuration of the control system of the first embodiment of the present invention;

FIG. 25 is a pattern diagram showing the configuration of the control system of the second embodiment of the present invention;

FIG. 26 shows another configuration of the control system of the second embodiment of the present invention;

FIG. 27 is a block diagram showing the configuration of the portable terminal of the second embodiment of the present invention;

FIG. 28 is a block diagram showing the configuration of the control terminal of the second embodiment of the present invention;

FIG. 29 is a flowchart showing the operation of the portable terminal of the second embodiment of the present invention;

FIG. 30 is a flowchart showing operation (login operation) of the control terminal of the second embodiment of the present invention;

FIG. 31 shows another configuration of the control system of the second embodiment of the present invention;

FIG. 32 shows another configuration of the control system of the second embodiment of the present invention;

FIG. 33 shows another configuration of the control system of the second embodiment of the present invention; and

FIG. 34 shows another configuration of the control system of the second embodiment of the present invention.

### DETAILED DESCRIPTION OF THE PREFERRED EMBODIMENTS

As shown in the Description of Prior Art Section, in the server based control system, there is need to remember the ID and password by writing it down on notepaper or the like and this has been problematic in that it is a big burden on the user and furthermore sometimes input errors occur. The method in which the account ID is registered in USB memory or the like and then authenticated by the USB memory is also problematic in that if the account ID has not been registered, service cannot be provided and files that are saved in USB memory cannot be printed.

Thus in the embodiments of the present invention, in the case where authentication information is stored in portable memory devices that can be carried around such as USB memory, SD cards and the like or in portable terminals, login as a registered user is permitted, and even in the case where the authentication information is not saved login as a guest user is permitted and thus various users may appropriately use the service. In addition, document applications may be stored in the control terminal performing authentication in the image processing device and document data stored in the portable terminal can be printed directly. The following is a detailed description with reference to the drawings.

### Embodiment 1

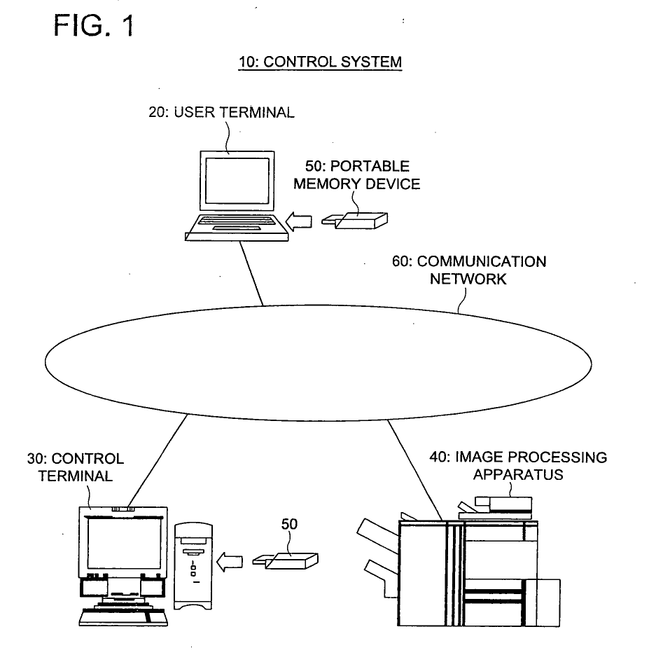

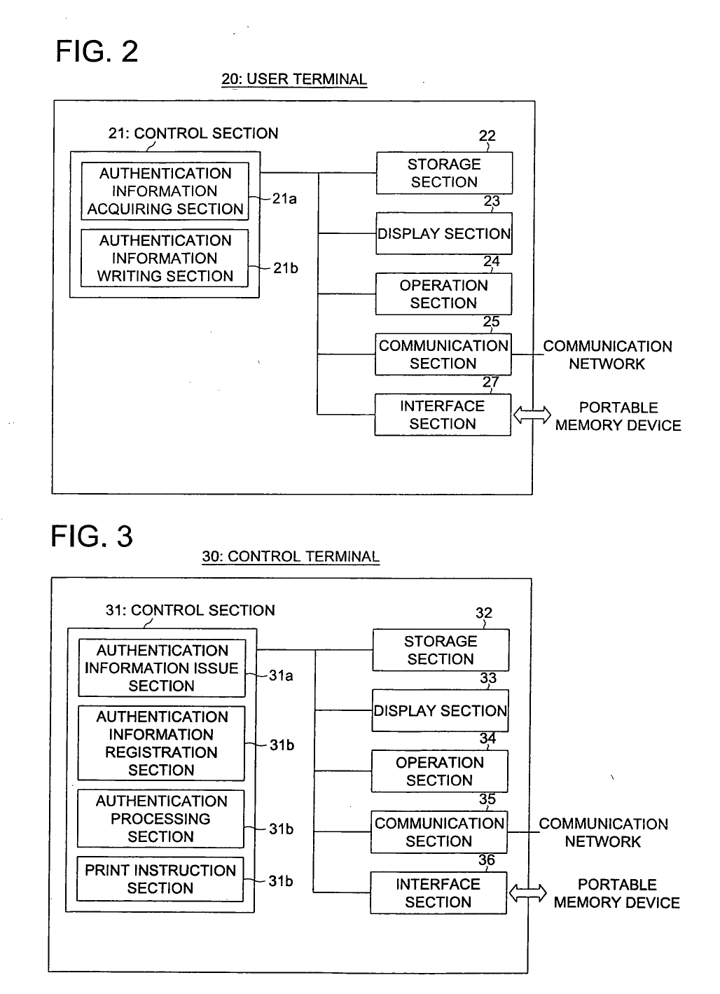

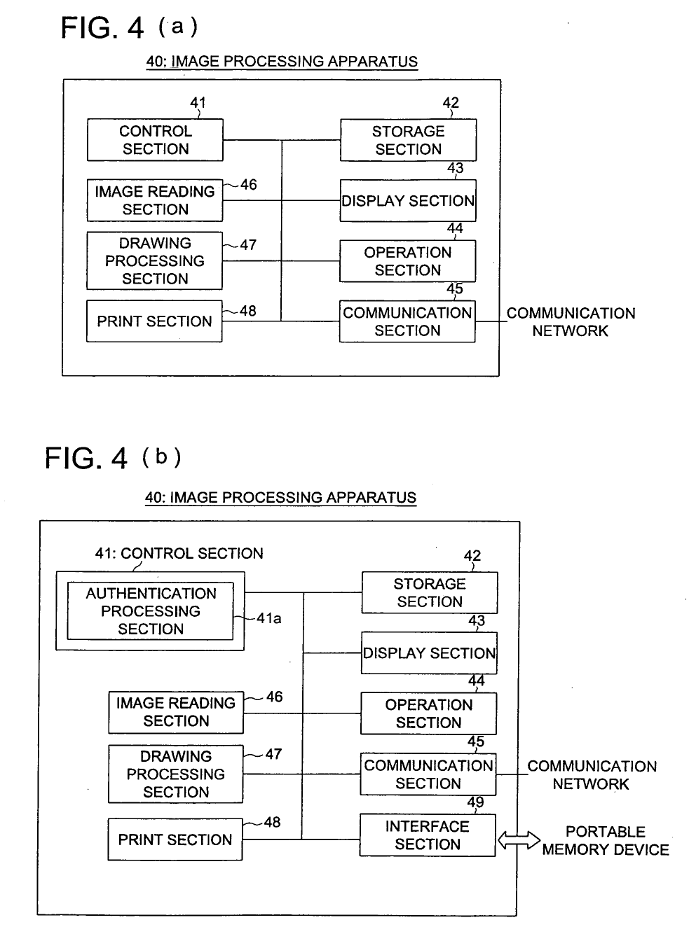

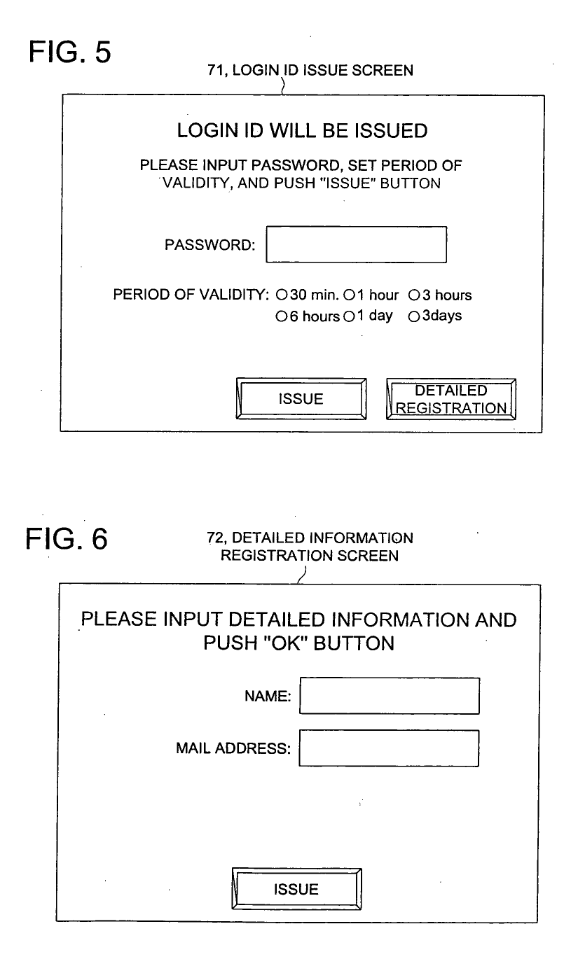

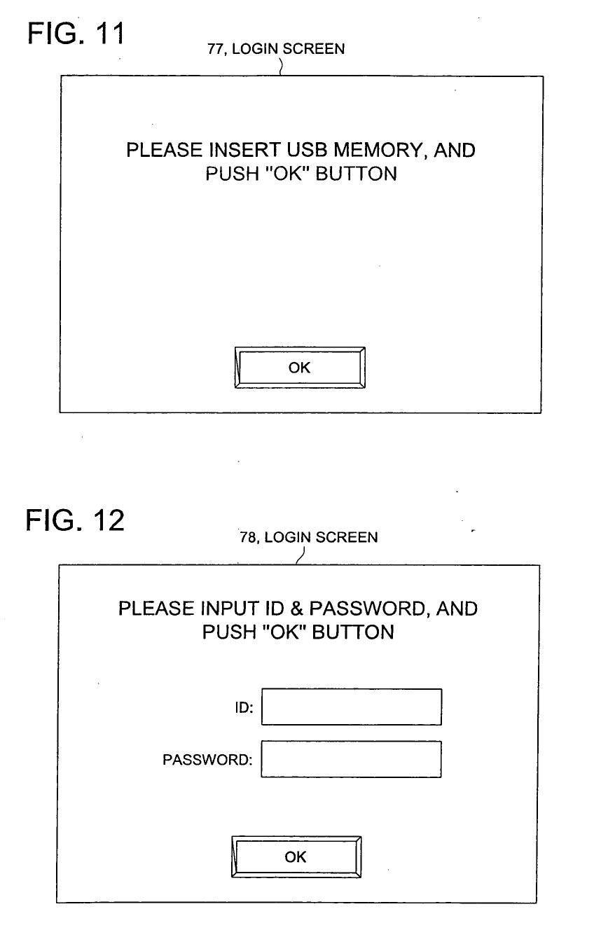

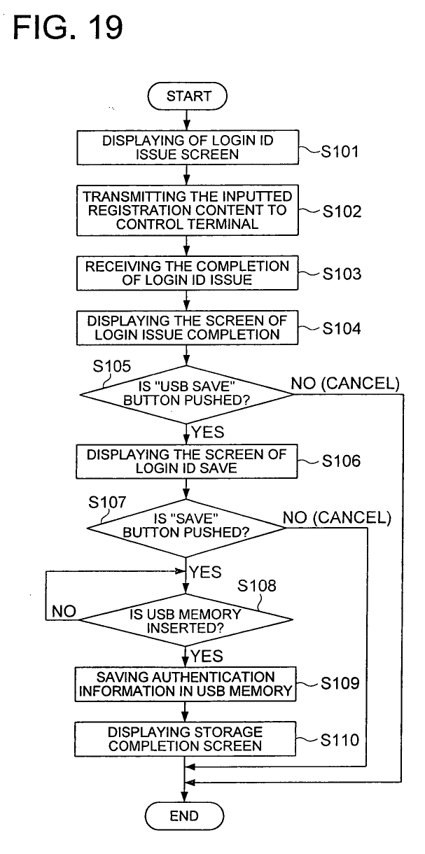

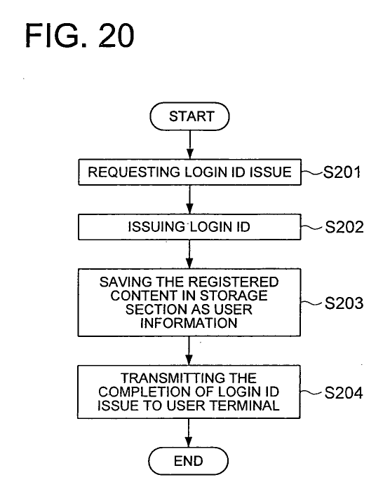

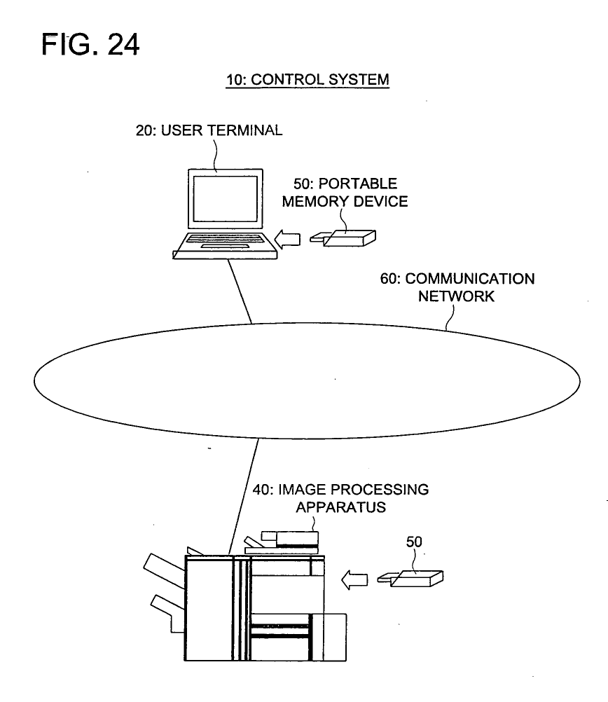

First, the control terminal, the image processing apparatus, the control system, the control program and the control method of the first embodiment of the present invention will be described with reference to FIG. 1-FIG. 24. FIG. 1 is a pattern diagram showing the configuration of the control system of this embodiment; FIG. 2 is a block diagram showing the configuration of the user terminal; FIG. 3 is a block diagram showing the configuration of the control terminal; FIG. 4 is a block diagram showing the configuration of the image processing apparatus. Also, FIGS. 5-10 show examples of the configuration of screens displayed in the display section of the user terminal, and FIGS. 11-18 show examples of the configuration of screens displayed at the display section of the control terminal. In addition FIG. 19 is a flowchart showing the process steps of the user terminal; FIG. 20-FIG. 23 are flowcharts showing the process steps of the control terminal. FIG. 24 shows another example of the control system of this embodiment.

As shown in FIG. 1, the control system 10 of this embodiment is installed in the hotel cabin or the like and one or more of user terminals 20 for obtaining the ID, passwords and the like for authenticating the user (called authentication information hereinafter); a one or more of control terminals 30 for performing authentic information issuing and registration and authentication processing and print instruction and the like; one or more of copiers or multifunction devices (the general term for these is image processing apparatus 40) which include copy function, facsimile function, printer function, scanner function and the like are connected by a communication network 60 such as a LAN (Local Area Network) or a WAN (wide area network).

In addition, as shown in FIG. 2, the user terminal 20 comprises a storage section 22 formed of ROM (Read Only Memory) and/or RAM (Random Access Memory) which store various data and programs; a display section 23 which is a CRT display or LCD (Liquid Crystal Display); an operation section 24 which is a keyboard, mouse or the like (or a touch panel which includes both the display section 23 and the operation section 24); a communication section 25 which is connected to the communication network 60; an interface section 26 for accessing a portable memory device 50 such as a USB memory or SD memory card, a smart media card, Compact Flash(registered trademark), Memory Stick (registered trademark), multimedia cards and the like (and in this embodiment, it is USB memory); and a control section 21 formed of a CPU (Central Processing Unit) and the like for controlling all these devices. The control section 21 comprises an authentication information acquiring section 21a which acquires authentication information from the control terminal 21 and an authentication information writing section 21b which writes the acquired authentication information onto the portable memory device 50. The authentication information acquiring section 21a and the authentication information writing section 21b may be in the form of hardware, or may be a control program which causes the computer to function as the authentication information acquiring section 21a and the authentication information writing section 21b and the control programs may be operated from the control section 21.

In addition, as shown in FIG. 3, the control terminal 30 comprises a storage section 32 that includes ROM and/or RAM which store various data and programs and document applications and the like; a display section 33 which is a CRT display or LCD or the like; an operation section 34 which is a keyboard, mouse or the like (or a touch panel which includes both the display section 33 and the operation section 34); a communication section 35 which is connected to the communication network 60; an interface section 36 for accessing a portable device 50; and a control section 31 formed of a CPU and the like for controlling all these devices. The control section 31 comprises an authentication information issue section 31a which issues authentication information; an authentication information registration section 31b which registers authentication information, and if necessary information relating to the user (called user information hereinafter) in the storage section 32; an authentication processing section 31c for performing authentication processing of the user based on the authentication information; and a print instruction section 31d for converting document data to print data which is PDL (page description language) and gives print instructions to the image processing apparatus 40. The authentication information issue section 31a, the authentication information registration section 31b, the authentication processing section 31c and the print instruction section 31d may be in the form of hardware, or may be a control program which causes the computer to function as the authentication information issue section 31a, the authentication information registration section 31b, the authentication processing section 31c and the print instruction section 31d, and the control program may be operated from the control section 31.

As shown in FIG. 4(a), the image processing apparatus 40 comprises a storage section 42 that includes ROM and/or RAM which store various data and programs; a display section 43; an operation section 44 (or a touch panel which includes both the display section 43 and the operation section 44); a communication section 45 which is connected to the communication network 60; an image reading section 46 such as a scanner; a drawing processing section 47 which creates intermediate data from print data transferred from the control terminal 30 and develops into bitmap data; a printing section for 48 for printing the bitmap data on paper; and a control section 41 formed from a CPU or the like which controls these sections. The print section 48 forms electrostatic latent images by irradiating light in accordance with bitmap data from an exposure device on a photoreceptor drum that is charged by a charging device, and the toner that is charged is attached and images are developed and then the toner images are transferred to paper media via a primary transfer roller and a second transfer roller and then fixed by a fixing device.

It is to be noted that the configuration shown in FIG. 1 is an example, and the communication network 60 may have a server for storing document data. In addition, in FIG. 1, the control system 10 has the control terminal 30, but the communication network 60 may have a server for issuing and registering the authentication information, and as shown in FIG. 4(b), the image processing apparatus 40 may have an interface 49 for accessing the authentication processing section 41a and the portable memory device 50. In this case, as shown in FIG. 24 the control terminal 30 does not need necessarily to be included.

The process which uses the control system shown in FIG. 1 will be described in the following. It is to be noted that in this embodiment, the user terminal 20 installed in the hotel cabin or the like is used to acquire authentication information and after the authentication information is saved in the portable memory device 50, login authentication is done at the control terminal 30 that is connected to the image processing apparatus 40 that is installed at the hotel lobby or the like, and the various functions of the image processing apparatus 40 are used, but the present invention is not to be limited by the following description.

The process at the time of user registration at the user terminal 20 will be described with reference to the flowchart in FIG. 19.

First, when the user using the hotel cabin operates the user terminal 20 using the operation section 24, in Step S101, the control section 21 displays a login ID issue screen 71 such as that shown in FIG. 5 in the display section 23.

The login ID issue screen 71 has a column for inputting the password set by the user and a column for setting the period of validity of the login ID, and when the user inputs the password and sets the period of validity and depresses the issue button, in Step S102, the control section 21 (authentication information acquiring section 21a) uses the communication section 25 to send the input password and the set period of validity to the control terminal 30 and an issue request for authentication information is sent.

It is to be noted that it is preferable that the password and the period of validity are set using the security screen, but this is not necessary. In addition, the configuration may be such that in order to perform additional service for the registered user described hereinafter, when the detailed registration button is depressed at the login ID issue screen 71, the detailed information screen 72 shown in FIG. 6 is displayed and name, detailed information (user information) such as e-mail address, room number and the like may be registered.

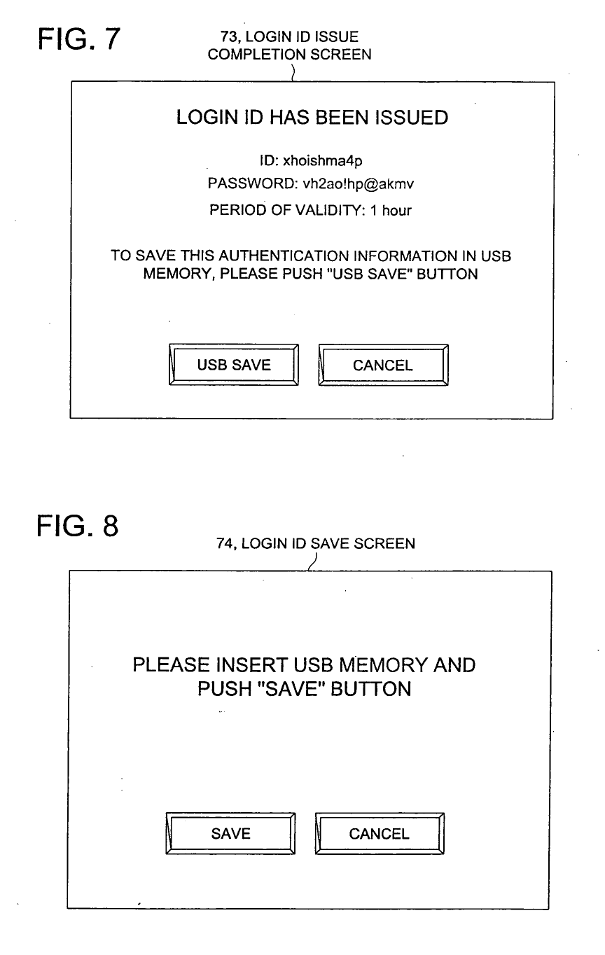

Next, in Step S103, when the control section 21 receives login ID issue completion from the control terminal 30, in Step S104, a login ID issue completion screen 73 such as that shown in FIG. 7 is displayed in the display section 23. At this login ID issue completion screen 73, the ID set by the control terminal 30 and if necessary the password and validity period set by the user of the control terminal 30 are displayed.

Next, in Step S105, the control section 21 monitors the depressions of the buttons, and when the depression of the “cancel” button is detected, processing ends while when the depression of the “USB save” button is detected, in Step S106, a login ID save screen 74 such as that shown in FIG. 8 is displayed in the display section 23 and the user is prompted to insert the portable memory device 50 in the interface section 26.

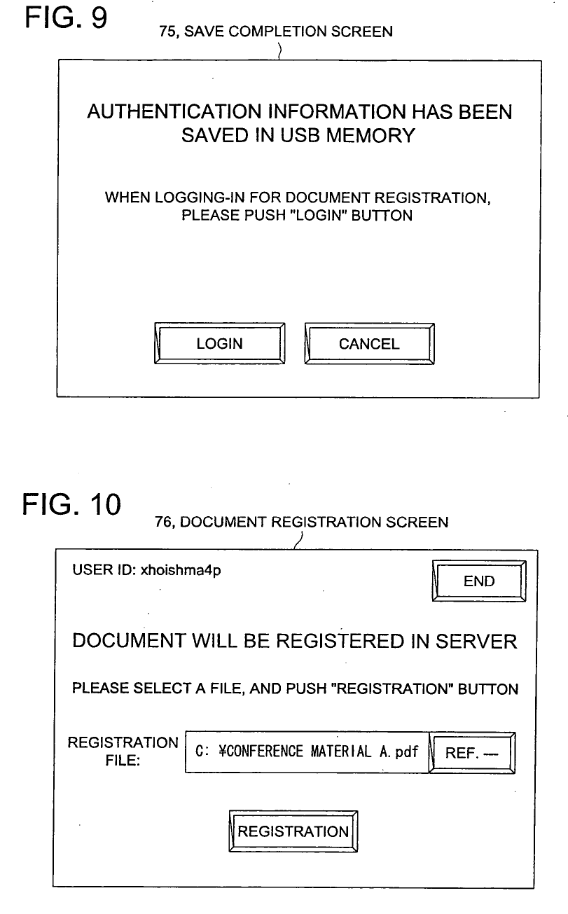

Next, in Step S107, the control section 21 monitors the depressions of the buttons, and when the depression of the “cancel” button is detected, processing ends, while when depression of the “Save” button is detected, in Step S108, a determination is made as to whether the portable memory device 50 is inserted in the interface section 26, and if insertion of the portable memory device is detected, in Step S109, the control section 21 (authentication information writing section 21b) saves the authentication information onto the portable memory device 50 and in Step S110, a save completion screen 75 such as that shown in FIG. 9 is displayed at the display section 23 and the process ends.

The user that has registered may login from the user terminal 20 by depressing the “login” button on the save completion screen 75 and at a document registration screen 76 such as that shown in FIG. 10, document registration on the control terminal 30 or the server can be performed. It is to be noted that in the case where authentication information is issued at the image processing apparatus 40 or the server, an acquire request for authentication information is sent to the image processing apparatus 40.

Next, the process at the time of user registration at the control terminal 30 will be described with reference to the flowchart in FIG. 20.

In the foregoing Step S102, registration content such as password and validity period and the like is sent from the user terminal 20 and login ID issue request is made (Step S201), and in Step S202, the control section 31 (authentication information issue section 31a) of the control terminal 30 issues the login ID in accordance with predetermined rules. In the case where the user has not set the password and validity period, the password and validity period are set as necessary.

No limitations/restrictions are imposed on the structure of the login ID, and for example, alphabet and numeric characters may be suitably combined. In addition, the login ID may be changed for each login ID issue request, or it may be changed for each user terminal 20, and in the case where it is not necessary to distinguish between registered users (for example in the case where it is sufficient just to distinguish between registered users and guest users) a specific login ID may be provided, and it may be changed each period (for example everyday or every hour).

Next, in Step S203, the control section 31 (authentication information registration section 31b) associates the issued login ID with the password and validity period and stores them in the storage section 32. In Step S204, the control section 31 uses the communication section 35 to transmit login ID issue completion (login ID and if necessary, password and validity period) to the user terminal 20.

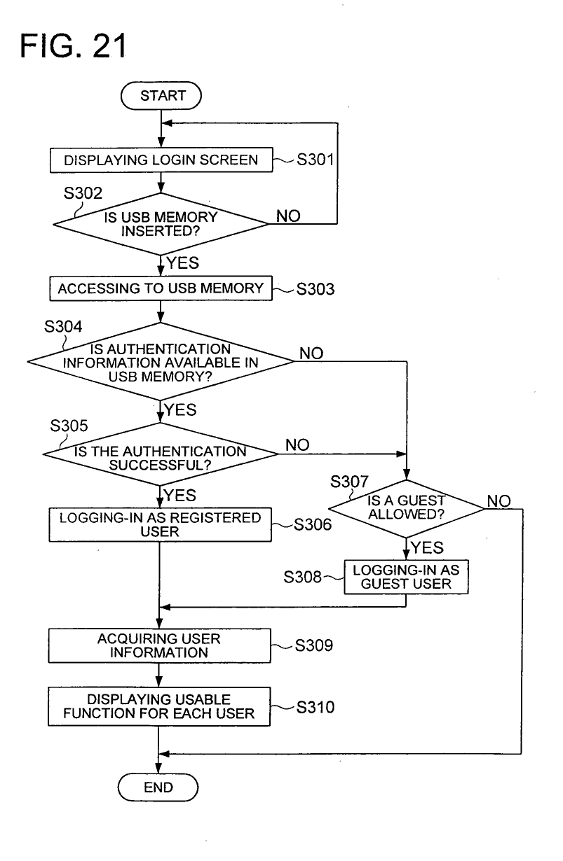

Next, the process at the time of login authentication at the control terminal 30 will be described with reference to the flowchart in FIG. 21.

When the user operates the operation section 34 of the control terminal 30, in Step S301, the control section 31 displays a login screen 77 such as that shown in FIG. 11 on the display section 33. It is to be noted that for a user who has performed the user registration but did not save the authentication information in the portable memory device 50, there may be a login screen 78 for inputting login ID and password as shown in FIG. 12 to thereby login.

Next, in Step S302, the control section 31 monitors insertion of the portable memory device 50 into the interface section 36 and depressions of the buttons, and when insertion of the portable memory device is detected and the depression of the “OK” button is detected, in Step S303 the portable memory device 50 is accessed via the interface section 36.

Next, in Step S304, the control section 31 (authentication processing section 31c) determines whether authentication information is available in portable memory device 50 and in the case where authentication information is available, the authentication information is read, and in Step S305, the storage section 32 is checked and authentication processing is performed based on whether or not the authentication information stored in the portable memory device 50 matches the authentication information registered in the storage section 32, and in the case where authentication is successful (that is when both match), in Step S306, login as a registered user is permitted.

Meanwhile, in the case where the authentication information is not available in the portable memory device 50 in Step S304, or in the case where the authentication was not successful in Step S305, in the prior art, login was not permitted and the process ended, but in this embodiment, in Step S307, the control section 31 (authentication processing section 31c) determines whether the control system 10 has permitted a guest login, and in the case where login was not permitted the process ends, and in the case where the guest login was permitted, in Step S308, login as a guest user is permitted.

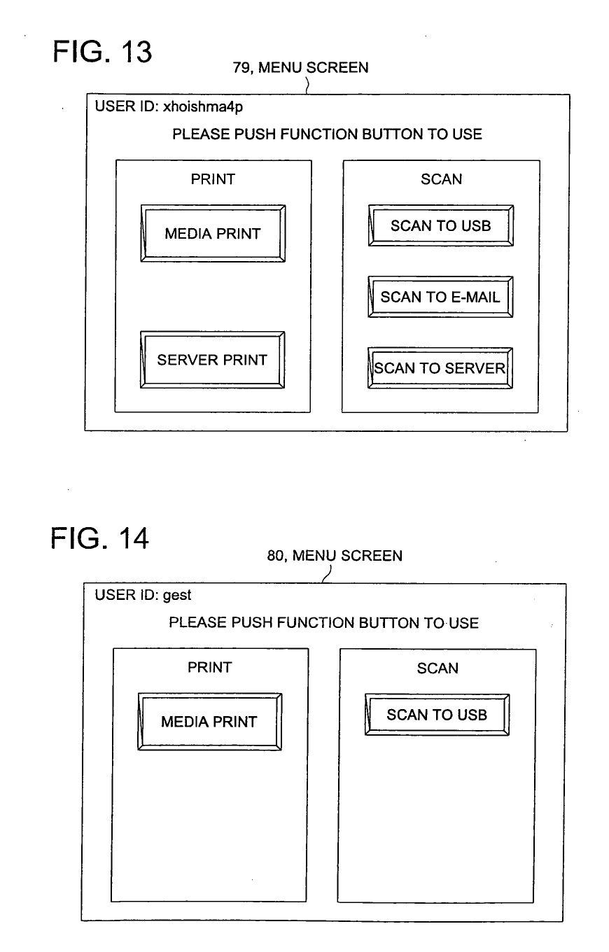

In addition, after login as a registered user or a guest user, in Step S309, the control section 31 acquires registered user information that has been associated with authentication information from the storage section 32 as necessary and in Step S310, and displays a menu of the usable functions for each user. For example, in the case of a registered user, a menu screen 79 such as that shown in FIG. 13 is displayed and in the case of a guest user, the menu screen 80 such as that shown in FIG. 14 is displayed.

It is to be noted that the registered user may perform selectable display of five functions which are: “media print” for printing document data stored in the portable memory device 50; “server print” which prints document data registered at the control terminal 30 or server; “Scan To USB” for saving scanned data in the portable memory device 50; “Scan To e-mail” for mail transfer of scanned data; and “Scan To Server” for saving the scanned data in the control terminal 30 or the server. The guest user may perform selectable display of two functions which are: “media print” and “Scan To USB”, but the types and number functions may be suitably set provided that the functions usable by the guest user is less than the functions usable by the registered user. Also, in FIG. 14, only the selectable functions are displayed, but all functions may be displayed and only specific functions from among these may be displayed so as to be selectable (that is, actively displayed) and by displaying all functions, the user that has logged in as a guest user can be prompted to login as a registered user.

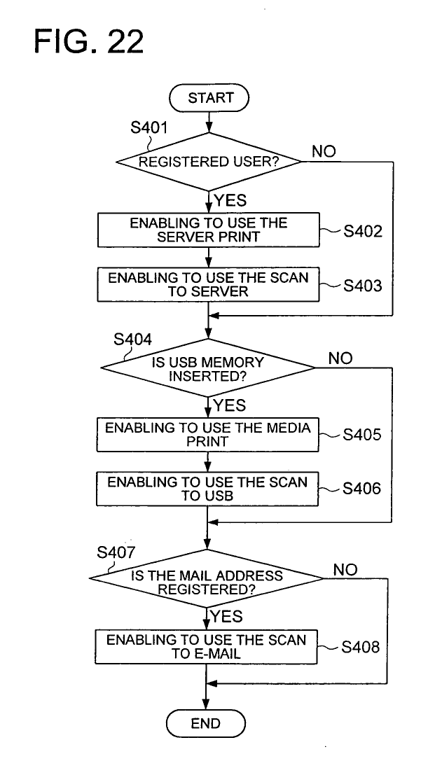

Next, the function selection process at the control terminal 30 will be described with reference to the flowchart in FIG. 22.

First in Step S401, the control section 31 determines whether the logged in user is a registered user or a guest user. In the case where the user is a registered user, if “server print” is selected at the menu screen 79, in Step S402, a server print screen 82 such as that shown in FIG. 16 is displayed in the display section 33 and it becomes possible for the user to print document data registered in the control terminal 30 or the server or the like and if “Scan To Server” is selected at the menu screen 79, in Step S403, the scan save function at the control terminal 30 is enabled. On the other hand, in the case where the user is logged in as a guest user, the above functions are not displayed on the menu screen 80 and these functions are disabled.

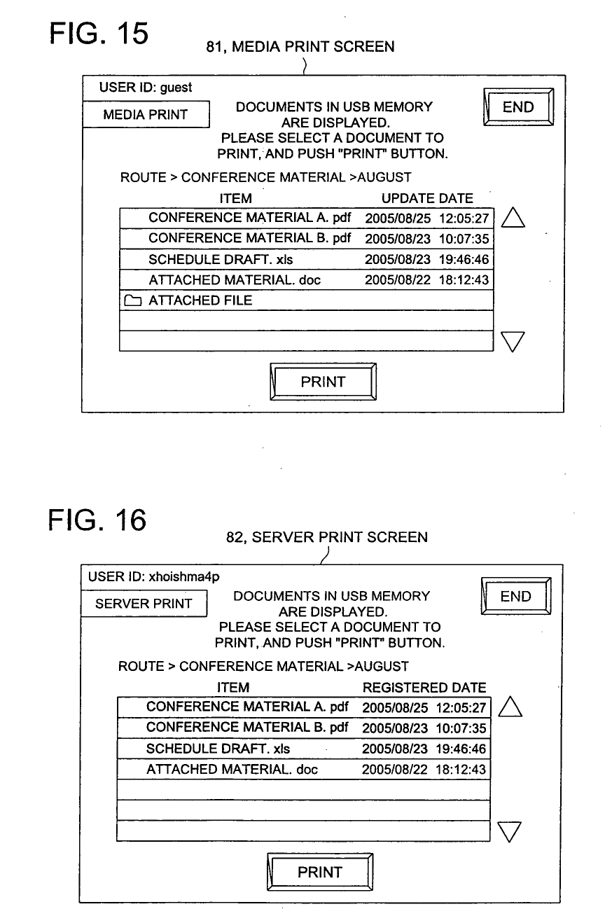

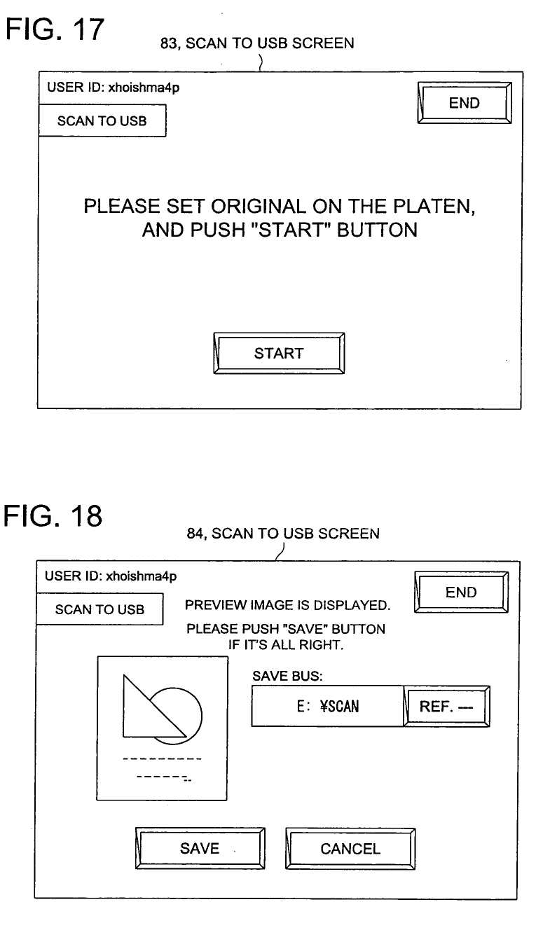

Next, in Step S404, the control section 31 determines whether the portable memory device 50 is inserted in the interface section 36, and in the case where the portable memory device 50 is inserted, if “media print” is selected in the menu screens 79 and 80, in Step S405, a media print screen 81 such as that shown in FIG. 15 is displayed at the display section 33 and use of media print is enabled, and in menu screen 79, if “Scan To USB” is selected, in Step S406, a Scan to USB screen 83 and 84 such as those shown in FIG. 17 and FIG. 18 are displayed at the display section 33, and at the image reading section 46 of the image processing apparatus 40, use of the save function for saving the scanned data to the portable memory device 50 is enabled.

Next, in Step S407, the control section 31 determines whether the mail address is registered in the storage section 32 as user information, and in the case where the mail address is registered, if “Scan To e-mail” is selected, in Step S408, mail transfer of the scanned data is enabled.

It is to be noted that, in this embodiment, the configuration is such that the functions that are usable by the registered user or the guest user may be changed, but rather than changing the useable functions, may be changed the conditions for use such as the data size of printable document data (for example limit the use of data size for documents for the guest user); the number of sheets that can be scanned or printed may be changed (for example limit the number of sheets for the guest user); the document size that can be scanned may be changed (for example limit the document size for the guest user); the content to be displayed may be changed (for example limit the number of document data display items for the guest user); or change the unit cost for printing and scanning.

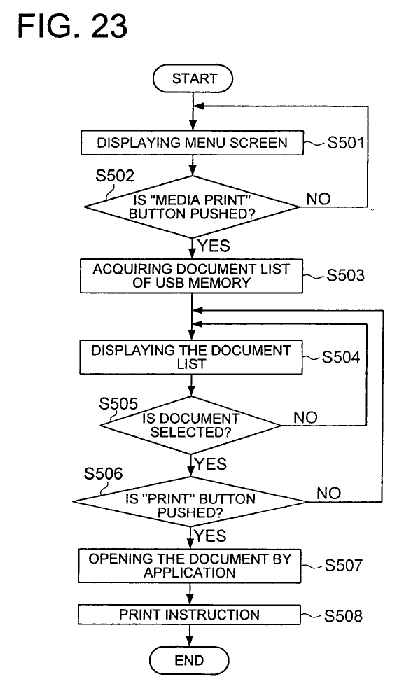

Next, the process for printing the document data saved in the portable memory device 50 will be described with reference to the flowchart in FIG. 23.

First, in Step 501, the control section 31 displays a menu screen 79 such as that shown in FIG. 13 or a menu screen 80 such as that shown in FIG. 14 at the display section 33.

Next, in Step S502, the control section 31 monitors the depressions of buttons and if pushing of the “media print” button is detected, in Step S503, the document data list saved in the portable memory device 50 that is inserted in the interface section 36 is obtained and in Step S504, the document list is displayed in the display section 33.

Next, in Step S505, the control section 31 monitors document selection, and when a document is selected, in Step S506, button depression is monitored, and if depression of the “print” button is detected, in Step S507, document application corresponding to the document selected from the storage section 42 is read and this application is used to open the document data.

Next, in Step S508, the control section 31 (print instruction section 31d) converts document data to print data described in PDL, and this print data is sent to the image processing apparatus 40 and thus a print instruction is given. Subsequently, the drawing processing section 47 of the image processing apparatus 40 creates intermediate data from print data and the intermediate data is developed to create bitmap data and then forwarded to the print section 48 and the print section 48 performs printing on a prescribed sheet based on the bitmap data.

By loading the application in the control terminal 30 in this manner, the document data saved in the portable memory device 50 can be printed directly. It is to be noted that in the case where the document data is not described by a page description language, it is necessary to convert the document data to print data using the document application, but in the case where the document data is data created based on XPS (XML Paper Specification), PDF (Portable Document Format) data; data described using PS (Post Script) or PCL (Printer Control Language) or the like, because the document data can be used at the image processing apparatus 40, the document application does not have to be stored in the print control terminal 30.

As described above, in the control section 31 of control terminal 30, because in the case where the authentication information is available in the portable memory device 50, login as a registered user is permitted and in the case where the authentication information is not available login as a guest user is permitted, various users can use the image processing apparatus 40 appropriately. In addition, document applications corresponding to the various documents are stored in the control terminal 30 and document data stored in the portable memory device 50 can be printed and thus the time and energy required to register the document data in the server in advance as is the case in the prior art, is saved. As a result, convenience for the user is improved.

### Embodiment 2

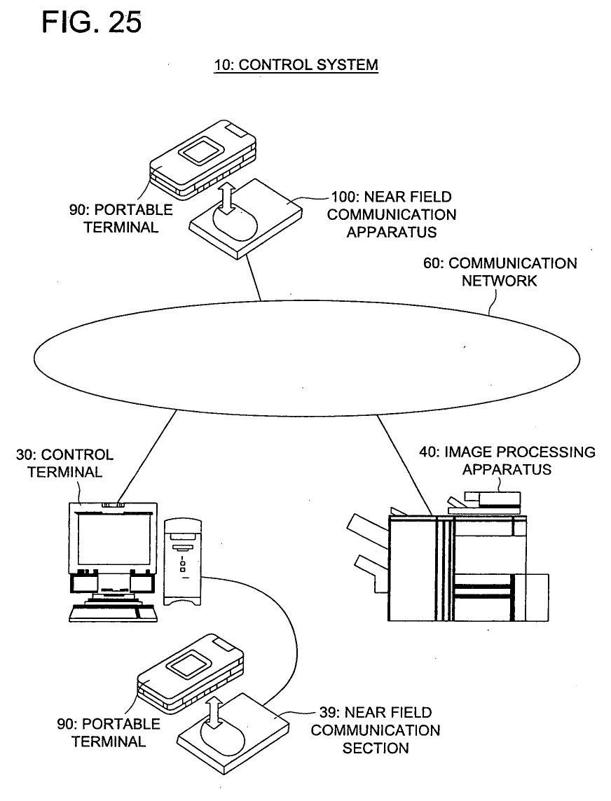

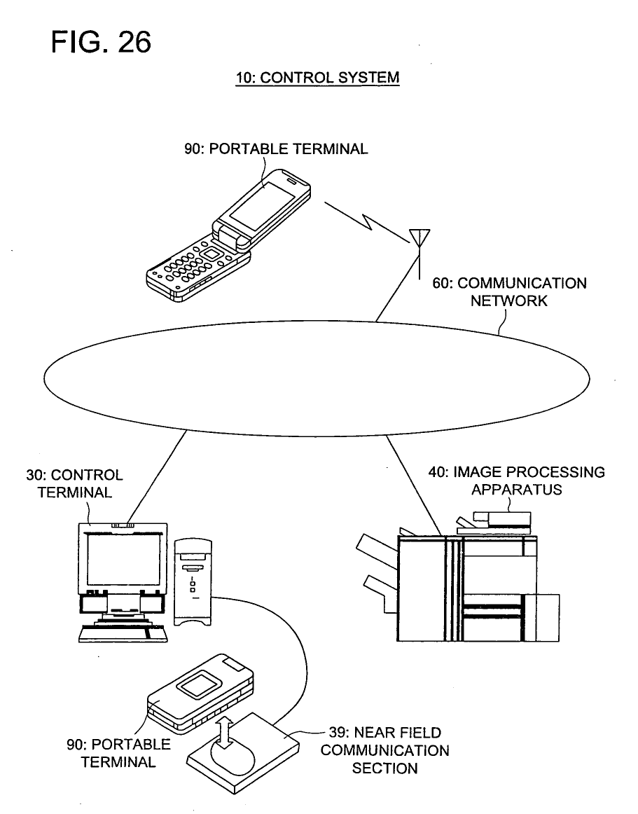

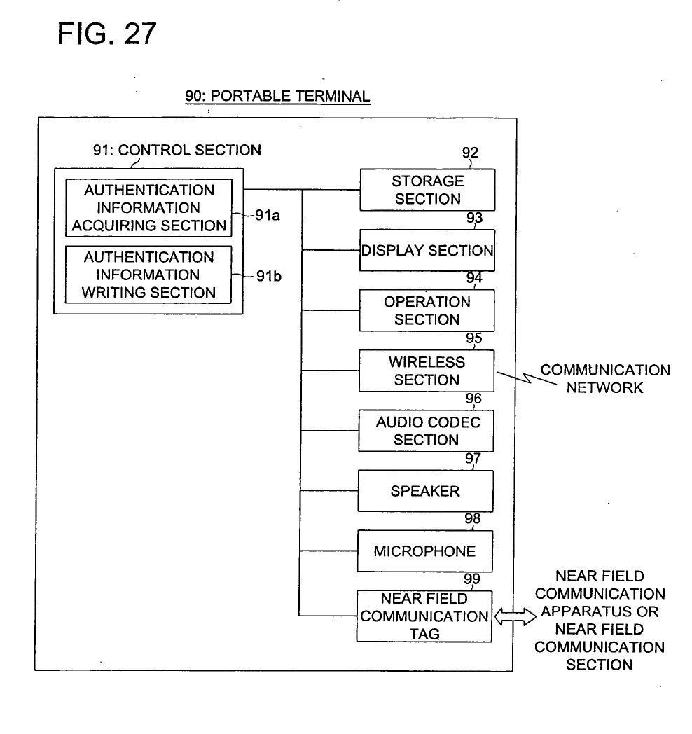

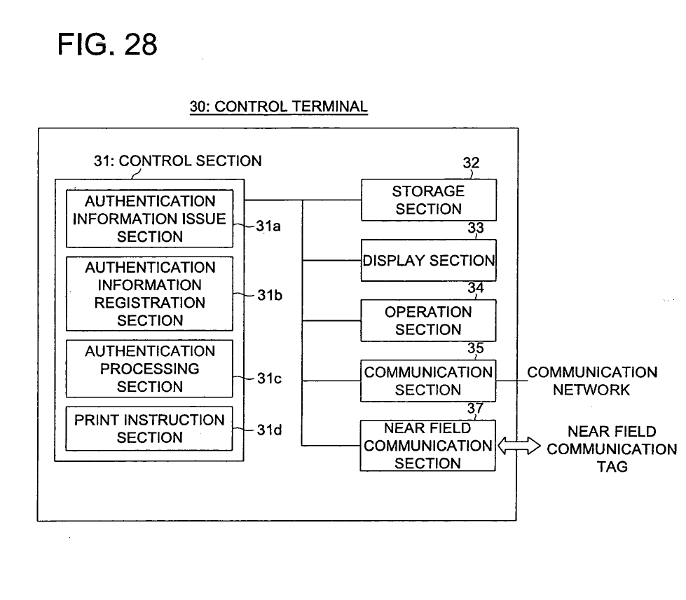

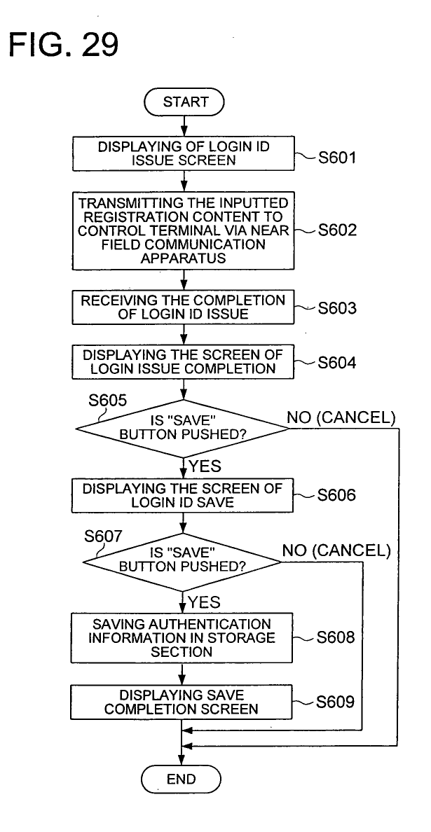

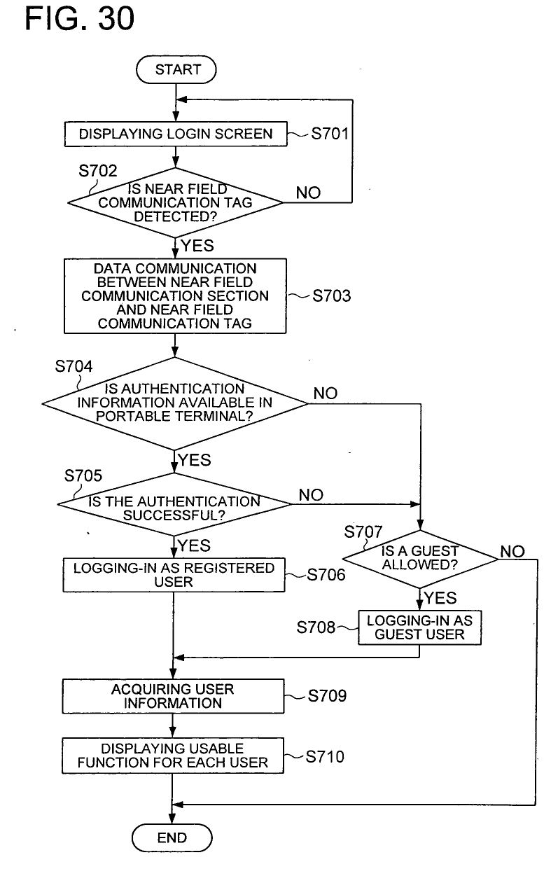

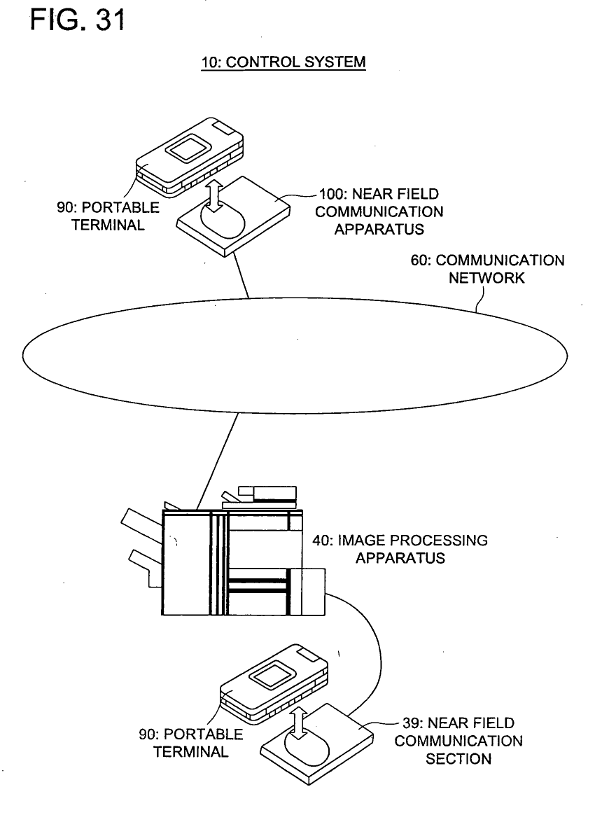

Next, the control terminal, the image processing apparatus, the control system, the control program and the control method of the second embodiment of the present invention will be described with reference to FIG. 25-FIG. 34. FIG. 25 and FIG. 26 are pattern diagrams showing the configuration of the control system; FIG. 27 is a block diagram showing the configuration of the portable terminal; FIG. 28 is a block diagram showing the configuration of the control terminal. FIG. 29 is a flowchart showing the process steps of the portable terminal; FIG. 30 is a flowchart showing the process steps of the control terminal. FIG. 31 to FIG. 34 show other configurations of the control system of this embodiment.

As shown in FIG. 25, the control system 10 of this embodiment comprise: one or a plurality of near field communication apparatus 100 which are installed in a hotel cabin (Communication apparatus 100 is a communication device which perform tag and data communication using electrostatic coupling, magnetic coupling or magnetic induction and generally called, near field communication device. Examples include RFID (Radio Frequency Identification), reader/writer devices and the like); one or more of portable terminals 90 which issue request for authentication information or store authentication information; one or more of control terminals 30 for performing authentic information issuing and registration and authentication processing and print instruction and the like; one or more of image processing apparatus 40 which include copy function, facsimile function, printer function, scanner function and the like; are these are connected by a communication network 60 such as a LAN (Local Area Network) or a WAN (wide area network).

In addition, as shown in FIG. 27, the portable terminal 90 comprises a storage section 92 formed of ROM and/or RAM; a display section 93 which is a CRT display or LCD; an operation section 94 which is formed of a direction key, ten-keys and special keys (or a touch panel which includes both the display section 93 and the operation section 94); a wireless section 95 which communicates wirelessly with a base station that is connected to the communication network 60; a audio coding section 96; a speaker 97; a mike 98; a near field communication apparatus 100; and a near field communication tag 99 for data communication between with the near field communication section 37 of the control terminal 30 (for example RFID tag and the like); and a control section 91 comprising a CPU or the like for controlling these devices. The near field communication tag 99 comprises at least an antenna coil formed of a resonant circuit and an IC which stores data, and the control section 91 comprises an authentication information acquiring section 91a for acquiring authentication information and an authentication information writing section 91b for writing the acquired authentication information onto the IC or the like of the near field communication tag 99. The authentication information acquiring section 91a and the authentication information writing section 91b may be in the form of hardware, or may be a control program which causes the computer to function as the authentication information issue section 31a and the authentication information registration section 31b, and the control programs may be operated from the control section 91.

In addition, the wireless section 95 receives signals at the antennae and the signal frequency is selected, signal conversion is carried out and the converted signals are amplified and demodulated and received data is output to the control section 91. The control section 91 processes the received data and outputs audio signal to the audio codec section 96, and the audio codec section 96 converts the audio signal to analog signal and the speaker 97 outputs audio. In addition, the audio input by the mike 98 is A/D converted to PCM signals at the audio codes section 96 and the control section 91 converts this signal to transmission data and the wireless section 95 modulates the transmission data and amplifies it as a stipulated carrier wave and transmits it from the antenna.

Also, as shown in FIG. 28, the control terminal 30 comprises a storage section 32 formed of ROM and/or RAM which stores various data and programs and document applications; a display section 33 which is a CRT display or LCD or the like; an operation section 34 which is a keyboard, mouse or the like (or a touch panel which includes both the display section 33 and the operation section 34); a communication section 35 which is connected to the communication network 60; a near field communication section 37 (for example RFID reader/writer or the like) for performing data communication with the near field communication tag 99 of the portable terminal 90; and a control section 31 formed of a CPU and the like for controlling all these devices. The control section 31 comprises authentication information issue section 31a which issues authentication information; an authentication information registration section 31b which registers authentication information in the storage section 32; an authentication processing section 31c for performing authentication processing of the user based on the authentication information; and a print instruction section 31d for converting document data to print data which is page description language and giving print instructions to the image processing apparatus 40. The authentication information issue section 31a, the authentication information registration section 31b, the authentication processing section 31c and the print instruction section 31d may be in the form of hardware, or may be a control program which causes the computer to function as the authentication information issue section 31a, the authentication information registration section 31b, the authentication processing section 31c and the print instruction section 31d, and the control programs may be operated from the control section 31.

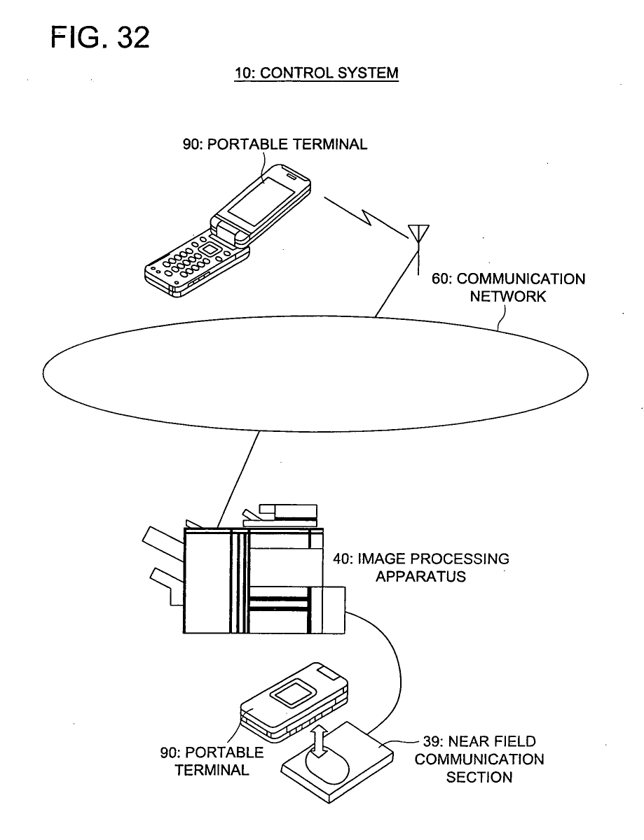

It is to be noted that the configuration of the image processing apparatus 40 is the same as that of the first embodiment described above and thus a description thereof has been omitted. In addition, in FIG. 25, the near field communication apparatus 100 is installed in guest rooms and the like and the portable terminal 90 acquires authentication information via the near field communication apparatus 100, but the portable terminal 90 may acquire authentication information using the wireless section 95, and in this case, as shown in FIG. 26, the near field communication apparatus 100 may be omitted. In addition, the configurations shown in FIG. 25 and FIG. 26 are examples, and the communication network 60 may have a server for storing document data. Also, in FIG. 25, the control system 10 has a control terminal 30, but the communication network 60 may include a server for issuing and registering authentication information, and the image processing apparatus 40 may have a near field communication section for accessing the authentication processing section 41a and the near field communication tag 99, and in this case as shown in FIG. 31 or FIG. 32, the control terminal 30 may be omitted.

The following is a description of the process which uses the control system 10 having the above configuration. It is to be noted that in this embodiment, the authentication information is obtained at the portable terminal 90 via the near field communication apparatus 100 installed in the hotel guest room or the like, and after the authentication information is saved in the portable terminal 90, login authentication is done at the control terminal 30 that is connected to the image processing apparatus 40 that is installed in the hotel lobby and the various functions of the image processing apparatus are used, but the present invention is not limited to following description.

First, the process at the time of user registration in the portable terminal 90 is described with reference to the flowchart shown in FIG. 29.

When the user using the hotel room performs a prescribed operation using the operation section 94 of the portable terminal 90, in Step S601, the control section 91 displays a login ID issue screen like that in the first embodiment on the display section 93.

The user then inputs the password and sets the validity period at the login ID issue screen, and when the portable terminal 90 is brought close on the near field communication apparatus 100, in Step S602, the control section 91 (the authentication information acquiring section 91a) uses the near field communication tag to send the input password and the set validity period to the control terminal 30 via the near field communication apparatus 100 and the login ID issue request is sent.

It is to be noted that setting of the password or validity period is not essential. Also the in order to perform additional services for users, the same detailed information registration screen like that in the first embodiment may be displayed and detailed information (user information) such as name, mail address, room number and the like may be registered and the control section 91 may obtain the name and mail address from the storage section 92 and automatically send it to the control terminal 30. In addition, as in the case of the configuration of FIG. 26, the password, validity period and detailed information may be transmitted using the wireless section 95.

Next, in Step S603, when the control section 91 receives login ID issue completion from the control terminal 30 via the near field communication apparatus 100, in Step S604, a login ID issue completion screen like that in the first embodiment is displayed at the display section 93. The login ID set at the control terminal 30 and the password and validity period set by the user or the control terminal if necessary are displayed at this log ID issue completion screen.

Next, in Step S605, the control section 91 monitors the pushing of the buttons and when pushing of the “cancel” button is detected, processing ends and when pushing of the “Save” button is detected, in Step S606, a login ID save screen like that in the first embodiment is displayed in the display section 93.

Next, in Step S607, the control section 91 monitors the depressions of the buttons and when the depression of the “cancel” button is detected, processing ends, while when the depression of the “Save” button is detected, in Step S608, the control section 91 (authentication information writing section 91b) saves the authentication information onto the IC of the near field communication tag 99 (or the storage section 92 which the near field communication tag 99 can use) and in Step S609, a save completion screen like that in the first embodiment is displayed at the display section 93 and the process ends.

The user that has registered may login from the portable terminal 90 by depressing the “login” button on the save completion screen and at a document registration screen like that in the first embodiment, document registration on the control terminal 30 or the server can be performed. It is to be noted that in the case where authentication information is issued at the image processing apparatus 40 or the server, acquire request for authentication information may be sent to the image processing apparatus 40 or the server. In addition, in the above flow, although the various screens are displayed at the display section 93 of the portable terminal 90 and the authentication information is stored in accordance with user operation, when login ID issue completion is received in Step S603 the authentication information can be automatically stored in the IC of the near field communication tag 99.

Next, the process at the time of login authentication at the control terminal 30 will be described with reference to the flowchart in FIG. 30. It is to be noted that the process at the time of user registration at the control terminal 30 is the same as that of first embodiment and thus a description thereof has been omitted.

When the user operates the operation section 34 of the control terminal 30, in Step 701, the control section 31 displays a login screen 77 such as that shown in FIG. 11 on the display section 33. It is to be noted that for a user who has performed the user registration but did not save the authentication information in the portable terminal 90, there may be a login screen 78 for inputting login ID and password as shown in FIG. 12 to thereby login.

Next, in Step S702, the control section 31 monitors the near field communication tag 99 using the near field communication section 37, and when the near field communication tag 99 is detected, in Step S703 data communication occurs between the near field communication section 37 and the near field communication tag 99.

Next, in Step S704, the control section 31 (authentication processing section 31c) determines whether authentication information is available in the portable terminal 90, and in the case where authentication information is available, the authentication information is read, and in Step S705, the storage section 32 is checked and authentication processing is performed based on whether or not the authentication information stored in the portable terminal 90 matches the authentication information registered in the storage section 32, and in the case where authentication is successful, in Step S706, login as a registered user is permitted.

Meanwhile, in the case where the authentication information is not available in portable terminal 90 in Step S704, or in the case where the authentication was not successful in Step S705, in Step S707, the control section 31 (authentication processing section 31c) determines whether the control system 10 has permitted guest login, and in the case where login has not been permitted the process ends, while in the case where login has been permitted, in Step 708, login as a guest user is permitted.

In addition, after login as a registered user or guest user, in Step S709, the control section 31 acquires registered user information that has been associated with authentication information from the storage section 32 as necessary, and in Step S710, displays a menu of the usable functions for each user. For example, in the case of a registered user, a menu screen 79 such as that shown in FIG. 13 is displayed and in the case of a guest user, the menu screen 80 such as that shown in FIG. 14 is displayed. It is to be noted that as is the case in the first embodiment, the types and numbers of functions and the display methods may be suitably selected.

After this, the functions of the image processing apparatus 40 are processed based on the flowchart in FIG. 22 and FIG. 23 of the first embodiment.

By using the portable terminal 90 in this manner, the user can obtain the authentication information at a preferred location (such as in the hotel lobby or the like), and thus convenience for the user is improved. In addition, because the user information in portable terminal 90 can be automatically sent when the authentication information is acquired, operational efficiency is also improved.

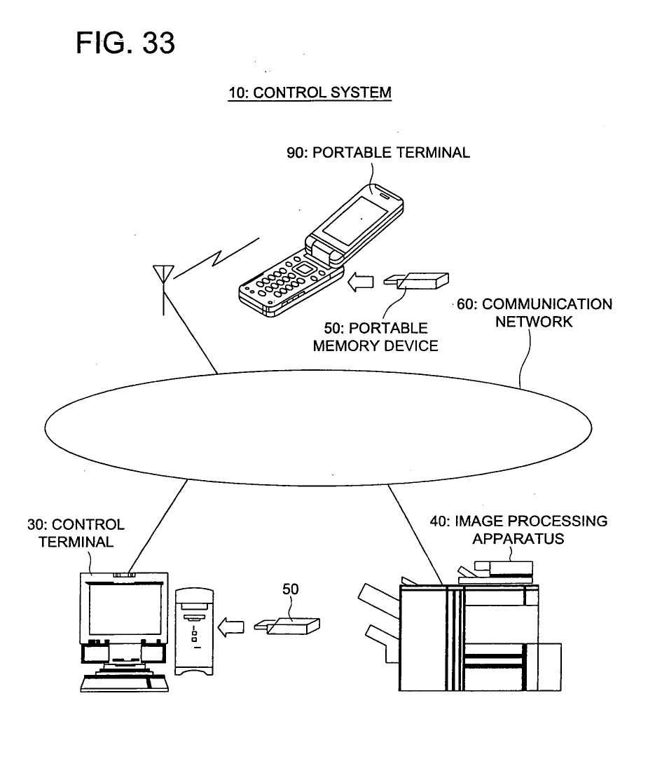

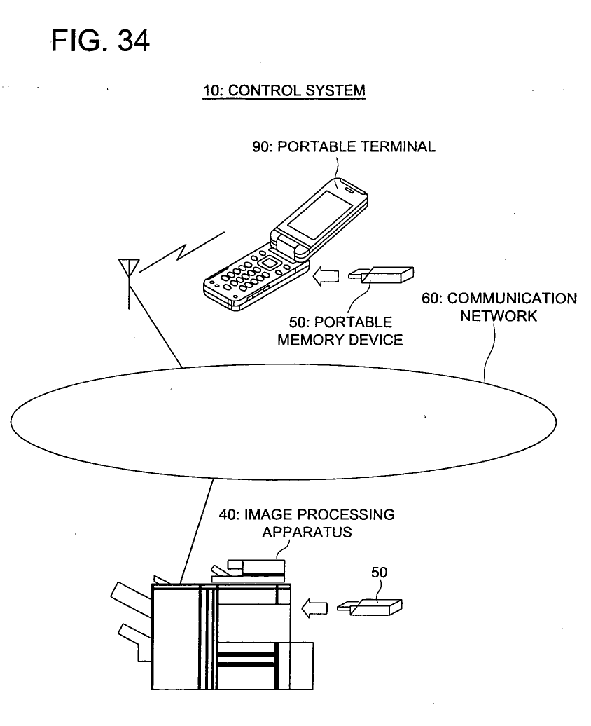

It is to be noted that in the description above, authentication information is stored in the IC of the near field communication tag 99 of the portable terminal 90 and the authentication processing is performed using the near field communication section 37 of the control terminal 30, but in the case where portable terminal 90 has an interface section of the portable memory device 50, as shown in FIG. 33 and FIG. 34, the authentication information acquired at the portable terminal 90 may be stored in the portable memory device 50 and this portable memory device 50 is used to perform the authentication process at the control terminal 30 and the image processing apparatus 40.

In addition, the above embodiments, the case where the functions of the image processing apparatus 40 were used was described, but the present invention is not to be limited to the above embodiments and may be applied in the same manner even in the case where suitably selected devices using the portable memory device 50 or the portable terminal 90 in which the authentication information is stored is used.

The present invention may be used for a suitably selected device, system, program or method which performs control based on authentication information stored in portable memory device such as USB memory and the like, or in a portable terminal.

What is claimed is:

1. A control terminal comprising:
an interface section to load a portable memory device;
an authentication information issue section which issues authentic information;
an authentic information registration section which registers the authentic information in a storage section; and
an authentication processing section which controls to determine whether the authentication information registered in the storage section is stored in the portable memory device loaded in the interface section, and in a case where the authentication information is stored in the portable memory device, controls to permit a login as a registered user, while in a case where the authentication information is not stored in the portable memory device, controls to permit a login as a guest user.

2. The control terminal of claim 1, further comprising a print instruction section which converts document data stored in the portable memory device into print data of a page description language by using an application having been stored in advance, and issues a print instruction based on the print data to an image processing apparatus connected to the control terminal.

3. A control terminal comprising:
a near field communication section which performs data communication with a near field communication tag of a portable terminal;
an authentication information issue section which issues authentic information;
an authentic information registration section which registers the authentic information in a storage section; and
an authentication processing section which controls to determine whether the authentication information registered in the storage section is stored in the near field communication tag which is performing data communication with the near field communication section, and in a case where the authentication information is stored in the near field communication tag, controls to permits a login as a registered user, while in a case where the authentication information is not stored in the near field communication tag, controls to permit a login as a guest user.

4. The control terminal of claim 3, further comprising a print instruction section which converts document data stored in the near field communication tag into print data of a page description language by using an application having been stored in advance, and issues a print instruction based on the print data to an image processing apparatus connected to the control terminal.

5. An image processing apparatus comprising:
an interface section to load a portable memory device; and
an authentication processing section which controls to determine whether authentication information registered in advance is stored in the portable storage device loaded in the interface section, and in a case where the authentication information is stored in the portable memory device, controls to permits a login as a registered user, while in a case where the authentication information is not stored in the portable memory device, controls to permit a login as a guest user.

6. The image processing apparatus of claim 5, wherein the control terminal is provide with a function to convert document data stored in the portable memory device into print data of a page description language by using an application having been stored in advance.

7. An image processing apparatus comprising:
a near field communication section which performs data communication with a near field communication tag of a portable terminal; and
an authentication processing section which controls to determine whether authentication information registered in advance is stored in the near field communication tag which is performing data communication with the near field communication section, and in a case where the authentication information is stored in the near field communication tag, controls to permit a login as a registered user, while in a case where the authentication information is not stored in the near field communication tag, controls to permit a login as a guest user.

8. The image processing apparatus of claim 7, wherein the control terminal is provide with a function to convert document data stored in the near field communication tag into print data of a page description language by using an application having been stored in advance.

9. A control system in which a user terminal provided with a first interface to load a portable memory and a control terminal provided with a second interface to load the portable memory device are connected via a communication network,
wherein the user terminal comprises:
an authentication information acquiring section which acquires authentication information from the control terminal via the communication network; and
an authentication information writing section which writes the authentication information onto the portable memory device by using the second interface,
wherein the control terminal comprises:
an authentication information issue section which issues the authentication information;
an authentication information registration section which registers the authentication information into a storage section; and
an authentication processing section which controls to determine whether the authentication information registered in the storage section is stored in the portable memory device loaded in the second interface section, and in a case where the authentication information is stored in the portable memory device, controls to permit a login as a registered user, while in a case where the authentication information is not stored in the portable memory device, controls to permit a login as a guest user.

10. The control system of claim 9, wherein an image processing apparatus is connected to the communication network, and the control terminal further comprises a print instruction section which converts document data stored in the portable memory device into print data of a page description language by using an application having been stored in advance, and issues a print instruction based on the print data to the image processing apparatus connected to the control terminal.

11. A control system in which a portable terminal provided with a near field communication tag, a near field communication apparatus to perform data communication with the near field communication tag, and a control terminal provided with a near field communication section to perform data communication with the near field communication tag are connected via a communication network.
wherein the portable terminal comprises:
an authentication information acquiring section which acquires authentication information from the control terminal via the communication network and the near field communication apparatus; and
an authentication information writing section which writes the authentication information into the near field communication tag,
wherein the control terminal comprises:
an authentication information issue section which issues the authentication information;
an authentication information registration section which registers the authentication information into a storage section; and
an authentication processing section which controls to determine whether the authentication information registered in the storage section is stored in the near field communication tag performing the data communication with the near field communication section, and in a case where the authentication information is stored in the near field communication tag, controls to permits a login as a registered user, while in a case where the authentication information is not stored in the near field communication tag, controls to permit a login as a guest user.

12. The control system of claim 11, wherein an image processing apparatus is connected to the communication network, and the control terminal further comprises a print instruction section which converts document data stored in the near field communication tag into print data of a page description language by using an application having been stored in advance, and issues a print instruction based on the print data to the image processing apparatus connected to the control terminal.

13. A control system in which a portable terminal provided with a near field communication tag and a control terminal provided with a near field communication section to perform data communication with the near field communication tag are connected via a communication network, wherein the portable terminal comprises:
an authentication information acquiring section which acquires authentication information from the control terminal via the communication network; and
an authentication information writing section which writes the authentication information onto the near field communication tag,
wherein the control terminal comprises:
an authentication information issue section which issues the authentication information;
an authentication information registration section which registers the authentication information into a storage section; and
an authentication processing section which controls to determine whether the authentication information registered in the storage section is stored in the near field communication tag performing the data communication with the near field communication section, and in a case where the authentication information is stored in the near field communication tag, controls to permits a login as a registered user, while in a case where the authentication information is not stored in the near field communication tag, controls to permit a login as a guest user.

14. The control system of claim 13, wherein an image processing apparatus is connected to the communication network, and the control terminal further comprises a print instruction section which converts document data stored in the near field communication tag into print data of a page description language by using an application having been stored in advance, and issues a print instruction based on the print data to the image processing apparatus connected to the control terminal.

15. A computer readable recording medium recorded thereon a program which operates on an apparatus provided with an interface section to load a portable memory device, wherein the program allows a computer to function as an authentication processing section which controls to determine whether the authentication information registered in advance is stored in the portable memory device loaded in the interface section, and in a case where the authentication information is stored in the portable memory device, controls to permits a login as a registered user, while in a case where the authentication information is not stored in the portable memory device, controls to permit a login as a guest user.

16. A computer readable recording medium recorded thereon a program which operates on an apparatus provided with a near field communication section which performs data communication with a near field communication tag in a portable terminal, wherein the program allows a computer to function as an authentication processing section which controls to determine whether the authentication information registered in advance is stored in the near field communication tag performing the data communication with the near field communication section, and in a case where the authentication information is stored in the near field communication tag, controls to permits a login as a registered user, while in a case where the authentication information is not stored in the near field communication tag, controls to permit a login as a guest user.

17. A control method for controlling a system in which a user terminal provided with a first interface to load a portable memory and a control terminal provided with a second interface to load the portable memory device are connected via a communication network, the control method comprising:
a first step, in the control terminal, of issuing an authentication information, transmitting the authentication information to the user terminal via the communication network, and registering the authentication information in a storage section of the control terminal;
a second step, in the user terminal, of acquiring the authentication information from the control terminal via the communication network, and writing the authentication information into the portable memory device by using the first interface;
a third step, in the control terminal, of accessing the portable memory device having been loaded in the second interface section; and
a fourth step, in the control terminal, of determining whether the authentication information registered in the storage section is stored in the portable memory device, and in a case where the authentication information is stored in the portable memory device, controlling to permits a login as a registered user, while in a case where the authentication information is not stored in the portable memory device, controlling to permit a login as a guest user.

18. The control method of claim 17, further comprising a fifth step in the control terminal, of converting document data stored in the portable memory device into print data of a page description language by using an application having been stored in advance, and issuing a print instruction based on the print data to an image processing apparatus connected to the control terminal.

19. A control method for controlling a system in which a portable terminal provided with a near field communication tag, a near field communication apparatus to perform data communication with the near field communication tag, and a control terminal provided with a near field communication section to perform data communication with the near field communication tag are connected via a communication network, the control method comprising:
a first step, in the control terminal, of issuing an authentication information, transmitting the authentication information to the portable terminal via the communication network and the near field communication apparatus, and registering the authentication information in a storage section of the control terminal;
a second step, in the portable terminal, of acquiring the authentication information from the control terminal via the communication network and the near field communication apparatus, and writing the authentication information in the near field communication tag;
a third step, in the control terminal, of accessing the near field communication tag by using the near field communication section; and
a fourth step, in the control terminal, of determining whether the authentication information registered in the storage section is stored in the near field communication tag, and in a case where the authentication information is stored in the near field communication tag, controlling to permits a login as a registered user, while in a case where the authentication information is not stored in the near field communication tag, controlling to permit a login as a guest user.

20. The control method of claim 19, further comprising a fifth step in the control terminal, of converting document data stored in the near field communication tag into print data of a page description language by using an application having been stored in advance, and issuing a print instruction based on the print data to an image processing apparatus connected to the control terminal.

21. A control method for controlling a system in which a portable terminal provided with a near field communication tag, and a control terminal provided with a near field communication section to perform data communication with the near field communication tag are connected via a communication network, the control method comprising:
a first step, in the control terminal, of issuing an authentication information, transmitting the authentication information to the portable terminal via the communication network, and registering the authentication information in a storage section of the control terminal;
a second step, in the portable terminal, of acquiring the authentication information from the control terminal via the communication network, and writing the authentication information in the near field communication tag;
a third step, in the control terminal, of accessing the near field communication tag by using the near field communication section; and
a fourth step, in the control terminal, of determining whether the authentication information registered in the storage section is stored in the near field communication tag, and in a case where the authentication information is stored in the near field communication tag, controlling to permits a login as a registered user, while in a case where the authentication information is not stored in the near field communication tag, controlling to permit a login as a guest user.

22. The control method of any one of claim 21, further comprising a fifth step in the control terminal, of converting document data stored in the near field communication tag into print data of a page description language by using an application having been stored in advance, and issuing a print instruction based on the print data to an image processing apparatus connected to the control terminal.
